(19) United States
(12) Patent Application Publication
(10) Pub. No.: US 2019/0318151 A1
(43) Pub. Date: Oct. 17, 2019

(54) IMAGE ANALYSIS APPARATUS, METHOD, AND PROGRAM

(71) Applicant: OMRON Corporation, Kyoto-shi (JP)

(72) Inventors: Daiki SHICHIJO, TOKYO (JP); Tomoyoshi AIZAWA, Kyoto-shi (JP); Hatsumi AOI, Kyoto-shi (JP)

(73) Assignee: OMRON Corporation, Kyoto-shi (JP)

(21) Appl. No.: 16/358,765

(22) Filed: Mar. 20, 2019

(30) Foreign Application Priority Data
Apr. 13, 2018 (JP) 2018-077885

(51) Int. Cl. G06K 9/00; G06T 7/231

(52) U.S. Cl. CPC G06K 9/00248; G06T 2207/30201; G06K 9/00845; G06T 7/231

(57) ABSTRACT

In a state where a tracking flag is on, a search controller determines, with respect to a previous frame, whether an amount of change in positional coordinates of a feature point of a face in the current frame is within a predetermined range, whether an amount of change in face orientation is within a predetermined angle range, and whether an amount of change in sight line direction is within a predetermined range. When the conditions are satisfied in all these determinations, the change in the detection result in the current frame with respect to the previous frame is considered as being within an allowable range, and continuously in a subsequent frame, detection processing for a face image is performed in accordance with a face image area saved in a tracking information storage unit.

### CROSS-REFERENCE TO RELATED APPLICATION

This application is based on Japanese Patent Application No. 2018-077885 filed with the Japan Patent Office on Apr. 13, 2018, the entire contents of which are incorporated herein by reference.

### FIELD

Embodiments relate to an image analysis apparatus, method, and program used for detecting a human face from a captured image, for example.

### BACKGROUND

For example, in a monitoring field such as driver monitoring, there have been proposed techniques in which an image area including a human face is detected from an image captured by a camera, and positions of a plurality of organs such as eyes, a nose, and a mouth, an orientation of the face, a sight line, and the like are detected from the detected face image area.

As a method for detecting the image area including the human face from the captured image, a known image processing technique such as template matching has been known. This technique is, for example, detecting from the captured image an image area in which the degree of matching with an image of a template is equal to or greater than a threshold value, while moving the position of a previously prepared face reference template stepwise with respect to the captured image at a predetermined number of pixel intervals, and extracting the detected image area with, for example, a rectangular frame to detect a human face.

As a technique for detecting the position of the organ and the orientation of the face from the detected face image area, for example, a technique for searching a plurality of organs of a face to be detected by using a face shape model is known. This technique is, for example, using a face shape model created in advance by learning or the like to search a feature point representing the position of each organ of the face from the face image area, and setting an area including the feature point as a face image when the reliability of the search result exceeds a threshold value (e.g., see Japanese Unexamined Patent Publication No. 2010-191592).

However, generally in the conventional face detection technique, as described in Japanese Unexamined Patent Publication No. 2010-191592, when the reliability of the search result of the face feature point does not satisfy the threshold value, the detection of the feature point is unconditionally determined to have failed and then the detection is restarted from detection of the face area. Therefore, even when the reliability of the detection result of the feature point temporarily decreases because a part of the face is temporarily hidden by the hand or hair, for example, the detection result of the feature point is determined to be a failure, and the face detection is restarted from the beginning. Further, when an image pattern similar to the feature of the face to be detected, such as the face of a person in the rear seat or the pattern of the seat is included in a simultaneously detected background image from the captured image, and the reliability of the image pattern is higher than the threshold value, the background image may be erroneously detected as an object to be detected instead of the face being the original object to be detected to make the face detection processing unstable, which has been problematic.

### SUMMARY

One or more aspects have been made in view of the above circumstances and may provide a technique in which erroneous detection of an object to be detected hardly occurs even when a temporary change occurs in the object to be detected, thereby improving the stability of a detection operation.

For solving the above problems, according to a first aspect, in an image analysis apparatus including a search unit that performs processing of detecting an image area including an object to be detected in units of frames from an image that is input in time series and estimating a state of the object to be detected based on the detected image area, there are further provided a reliability detector that detects a reliability indicating likelihood of the state of the object to be detected estimated by the search unit, and a search controller that controls the processing performed by the search unit based on the reliability detected by the reliability detector.

When a reliability detected in a first frame is determined to satisfy a reliability condition, the search controller saves into a memory a position of an image area detected by the search unit in the first frame and controls the search unit such that processing of estimating the state of the object to be detected in a second frame subsequent to the first frame is performed taking the saved position of the image area as a reference.

Further, the search controller determines whether a change in the state of the object to be detected estimated by the search unit in the second frame from the first frame satisfies a preset determination condition. Then, when the change is determined to satisfy the determination condition, the estimation processing for the state of the object to be detected in a third frame subsequent to the second frame is performed taking the saved position of the image area as a reference.

In contrast, when the change in the state of the object to be detected from the first frame is determined not to satisfy the determination condition, the search controller deletes the position of the image area saved in the memory, and the processing performed by the search unit in the third frame subsequent to the second frame is performed from the processing of detecting the image area for the entire image frame.

Therefore, according to a first aspect, when the reliability of the state of the object to be detected estimated by the search unit in the first frame of the image satisfies the predetermined reliability condition, a search mode called a tracking mode is set, for example. In the tracking mode, the position of the image area detected by the search unit in the first frame is saved into the memory. At the time of estimating the state of the object to be detected in the second frame subsequent to the first frame, the search unit performs processing of detecting the image area including the object to be detected by taking the saved position of the image area as a reference and estimating the state of the object to be detected based on this image area. Hence the image area can be efficiently detected as compared with a case where processing is performed to always detect the image area including the object to be detected from the initial state in all frames and estimate the state of the object to be detected.

According to a first aspect, it is determined whether an amount of interframe change in the state of the object to be detected estimated by the search unit satisfies a predetermined determination condition in a state where the tracking mode is set. Then, when the predetermined determination is satisfied, the state of the object to be detected estimated in the second frame is considered as being within an allowable range, and continuously in the subsequent third frame, processing of detecting the image area by the tracking mode and estimating the state of the object to be detected is performed.

For this reason, in the field of driver monitoring, for example, when a part of the driver's face is temporarily hidden by the hand, hair, or the like or a part of the face is temporarily out of a reference position of a face image area, the tracking mode is kept, and in the subsequent frame, the detection processing for the image area by the tracking mode and the estimation processing for the state of the object to be detected is performed continuously. It is thereby possible to enhance the stability of the detection processing for the image area of the object to be detected and the estimation processing for the state of the object to be detected.

Further, according to a first aspect, the tracking mode is canceled unless the amount of interframe change in the state of the object to be detected satisfies the predetermined determination condition, and from the next frame, an image area including the object to be detected is again detected with the whole area of the image set as the search range, to estimate the state of the object to be detected. For this reason, when the reliability of the estimation result of the state of the object to be detected falls on or below the determination condition during setting of the tracking mode, in the next frame, processing is performed to detect the image area from the initial state and estimate the state of the object to be detected. Therefore, in a state where the reliability has decreased, the tracking mode is quickly cancelled, so that the state of the object to be detected can be grasped with high accuracy.

A second aspect of the apparatus is that in a first aspect, the search unit sets a human face as the object to be detected, and estimates at least one of each of positions of a plurality of feature points preset for a plurality of organs constituting the human face, an orientation of the face, and a sight line direction of the face.

According to a second aspect, for example, it is possible to reliably and stably estimate the state of the driver's face in the field of driver monitoring.

A third aspect of the apparatus is that in a second aspect, the search unit performs processing of estimating the positions of the plurality of feature points preset for the plurality of organs constituting the human face in the image area, and the second determination unit has a first threshold value defining an allowable amount of interframe change in the position of each of the feature points as the determination condition, and determines whether an amount of a change in the position of the feature point between the first frame and the second frame exceeds the first threshold value.

According to a third aspect, for example, in a case where the reliability of the estimation result of the feature point position of the driver's face decreases, when the amount of interframe change in the feature point position is equal to or smaller than the first threshold value, the change in the feature point position is considered as being within the allowable range, and the tracking mode is continued. Therefore, when the reliability of the estimation result of the face feature point temporarily decreases, efficient processing can be continued in accordance with the tracking mode.

A fourth aspect of the apparatus is that in a second aspect, the search unit performs processing of estimating from the image area the orientation of the human face with respect to a reference direction, and the second determination unit has, as the determination condition, a second threshold value defining an allowable amount of interframe change in the orientation of the human face estimated by the search unit, and determines whether an amount of a change in the orientation of the human face between the first frame and the second frame exceeds the second threshold value.

According to a fourth aspect, for example, in a case where the reliability of the estimation result of the orientation of the driver's face decreases, when the amount of interframe change in the orientation of the face is equal to or smaller than the second threshold value, the change in the face orientation is considered as being within the allowable range, and the tracking mode is continued. Therefore, when the reliability of the estimation result of the orientation of the face temporarily decreases, efficient processing can be continued in accordance with the tracking mode.

A fifth aspect of the apparatus is that in a second aspect, search unit performs processing of estimating the sight line of the human face from the image area, and the second determination unit has, as the determination condition, a third threshold value defining an allowable amount of interframe change in the sight line direction of the object to be detected, and determines whether an amount of a change in the sight line direction of the human face between the first frame and the second frame exceeds the third threshold value, the sight line direction being detected by the search unit.

According to a fifth aspect, for example, in a case where the reliability of the estimation result of the sight line direction of the driver decreases, when the amount of interframe change in the sight line direction is equal to or smaller than the third threshold value, the change in the sight line direction is considered as being within the allowable range, and the tracking mode is continued. Therefore, when the reliability of the estimation result of the sight line direction temporarily decreases, efficient processing can be continued in the tracking mode.

That is, according to one or more aspects, it is possible to provide a technique in which erroneous detection of an object to be detected hardly occurs even when a temporary change occurs in the object to be detected, thereby improving the stability of a detection operation.

### BRIEF DESCRIPTION OF THE DRAWINGS

FIG. 1 is a block diagram illustrating one application example of an image analysis apparatus according to one or more embodiments;

FIG. 2 is a block diagram illustrating an example of a hardware configuration of an image analysis apparatus according to one or more embodiments;

FIG. 3 is a block diagram illustrating an example of a software configuration of an image analysis apparatus according to one or more embodiments;

FIG. 4 is a flow diagram illustrating an example of a procedure and processing contents of learning processing by an image analysis apparatus, such as in FIG. 3;

FIG. 5 is a flow diagram illustrating an example of entire processing procedure and processing contents of image analysis processing by an image analysis apparatus, such as in FIG. 3;

FIG. 6 is a flow diagram illustrating one of subroutines of image analysis processing, such as in FIG. 5;

FIG. 7 is a flow diagram illustrating an example of a processing procedure and processing contents of feature point search processing in image analysis processing, such as in FIG. 5;

FIG. 8 is a diagram illustrating an example of a face area extracted by face area detection processing, such as in FIG. 5;

FIG. 9 is a diagram illustrating an example of face feature points detected by feature point search processing, such as in FIG. 5;

FIG. 10 is a diagram illustrating an example in which a part of a face area is hidden by a hand;

FIG. 11 is a diagram illustrating an example of feature points extracted from a face image; and

FIG. 12 is a diagram illustrating an example in which feature points extracted from a face image are three-dimensionally displayed.

### DETAILED DESCRIPTION

Embodiments will be described below with reference to the drawings.

### Application Example

First, an application example of the image analysis apparatus according to one or more embodiments will be described.

For example, the image analysis apparatus according to one or more embodiments is used, for example, in a driver monitoring system to monitor positions of a plurality of feature points preset for a plurality of organs (eyes, nose, mouth, cheekbones, etc.) constituting the driver's face, the orientation of the driver's face, the sight line direction, and the like, and is configured as follows.

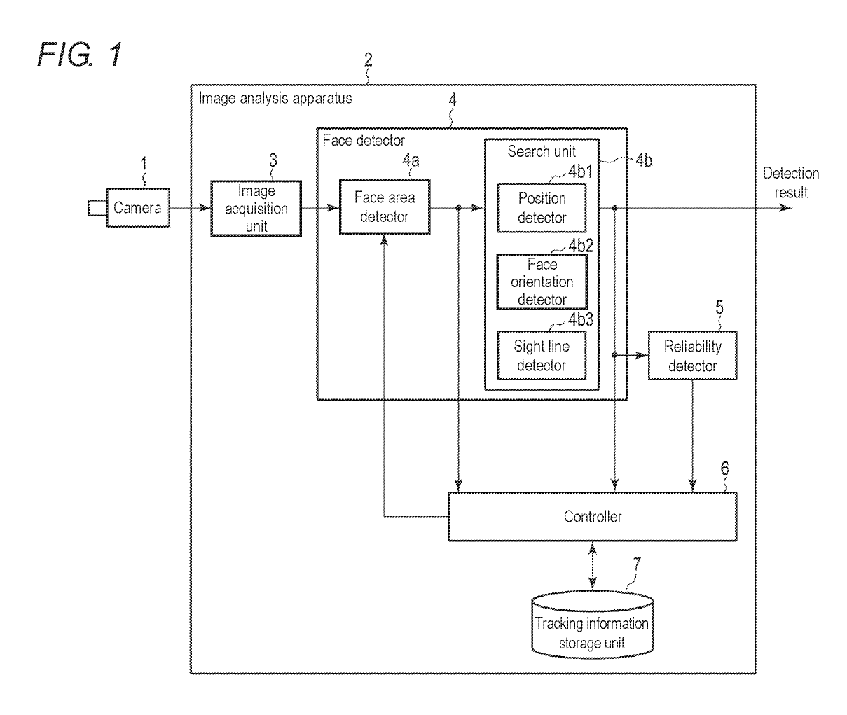

FIG. 1 is a block diagram illustrating a functional configuration of an image analysis apparatus used in the driver monitoring system. An image analysis apparatus 2 is connected to a camera 1. For example, the camera 1 is installed at a position facing the driver's seat, captures an image of a predetermined range including the face of the driver seated in the driver's seat in a constant frame period, and outputs the image signal.

The image analysis apparatus 2 includes an image acquisition unit 3, a face detector 4, a reliability detector 5, a search controller 6 (also referred to simply as controller), and a tracking information storage unit 7.

For example, the image acquisition unit 3 receives image signals that are output in time series from the camera 1, transforms the received image signals into image data made up of digital signals for each frame, and stores the image data into the image memory.

The face detector 4 includes a face area detector 4a and a search unit 4b. The face area detector 4a reads the image data acquired by the image acquisition unit 3 from the image memory for each frame and extracts an image area (partial image) including the driver's face from the image data. For example, the face area detector 4a uses a template matching method. While moving a position of a face reference template stepwise with respect to the image data at a predetermined number of pixel intervals, the search unit 4 detects, from the image data, an image area in which the degree of matching with the image of the reference template exceeds the threshold value, and extracts the detected image area. For example, a rectangular frame is used to extract the face image area.

The search unit 4b includes, as its functions, a position detector 4b1 that detects a position of a feature point of the face, a face orientation detector 4b2, and a sight line detector 4b3. For example, the search unit 4b uses a plurality of three-dimensional face shape models prepared for a plurality of angles of the face. In the three-dimensional face shape model, three-dimensional positions of a plurality of organs (e.g., eyes, nose, mouth, cheekbones) of the face corresponding to a plurality of feature points to be detected are defined by feature point arrangement vectors.

For example, by sequentially projecting the plurality of three-dimensional face shape models onto the extracted face image area, the search unit 4b acquires feature amounts of the respective organs from the face image area detected by the face area detector 4a. Three-dimensional positional coordinates of each feature point in the face image area are estimated based on an error amount with respect to a correct value of the acquired feature amount and the three-dimensional face shape model at the time when the error amount is within a threshold value. Then, each of the face orientation and the sight line direction is estimated based on the estimated three-dimensional positional coordinates of each feature point.

The search unit 4b can perform the search processing in two stages, such as first estimating positions of representative feature points of the face by rough search and then estimating positions of many feature points by detailed search. The difference between the rough search and the detailed search is, for example, the number of feature points to be detected, the dimension number of the feature point arrangement vector of the corresponding three-dimensional face shape model, and the determination condition for determining the error amount with respect to the correct value of the feature amount.

In the detailed search, in order to accurately detect the face from the face image area, for example, a large number of feature points to be detected are set, and the dimension number of the feature point arrangement vector of the three-dimensional face shape model is made multi-dimensional, and furthermore, the determination condition for the error amount with respect to the correct value of the feature amount, acquired from the face image area, is set severely. For example, the determination threshold value is set to a small value. In contrast, in the rough search, in order to detect the feature points of the face in a short time, the dimension number of the feature point arrangement vector of the three-dimensional face shape model is reduced by limiting the feature points to be detected, and further, the determination threshold value is set to a larger value so that the determination condition for the error amount is more relaxed than in the case of the detailed search.

The reliability detector 5 calculates the reliability indicating the likelihood of the estimation result of the position of the feature point obtained by the search unit 4b. As a method for calculating the reliability, for example, there is used a method in which a feature of a face image stored in advance and the feature of the face image area detected by the search unit 4b are compared to obtain a probability that an image of the detected face area is the image of the subject, and the reliability is calculated from this probability. As another detection method, it is possible to use a method of calculating a difference between the feature of the face image stored in advance and the feature of the image of the face area detected by the search unit 4b, and calculates the reliability from the magnitude of the difference.

The search controller 6 controls the operation of the face detector 4 based on the reliability detected by the reliability detector 5. For example, when the reliability of the estimation result obtained by the search unit 4b exceeds the threshold value in the current frame of the image, the search controller 6 sets a tracking flag on and stores a face image area detected by the face area detector 4a at this time into the tracking information storage unit 7. That is, the tracking mode is set. Then, the saved face image area is provided to the face area detector 4a so as to be a reference position for detecting the face image area in the subsequent frame.

Further, in a state where the tracking mode is set, the search controller 6 determines whether or not the state of change in the estimation result in the current frame with respect to the estimation result in the previous frame satisfies a preset determination condition.

Here, the following three types are used as the determination conditions:
(a) the amount of change in positional coordinates of the feature point of the face is within a predetermined range;
(b) the amount of change in the orientation of the face is within a predetermined angle range; and
(c) the amount of change in the sight line direction is within a predetermined range.

When determining that the amount of change in the estimation result in the current frame with respect to the estimation result in the previous frame satisfies all the above three types of determination conditions (a) to (c), the search controller 6 holds the face image area stored in the tracking information storage unit 7 while keeping the tracking flag on, namely, keeping the tracking mode. Then, the search controller 6 continuously provides the coordinates of the stored face image area to the face area detector 4a to the face detector 4 so that the face image area can be used as the reference position for detecting the face area in the subsequent frame.

In contrast, when the change in the estimation result in the current frame with respect to the estimation result in the previous frame does not satisfy any one of the above three types of determination conditions, the search controller 6 resets the tracking flag to be off and deletes the coordinates of the face image area stored in the tracking information storage unit 7. That is, the tracking mode is canceled. Then, the face area detector 112 is instructed to restart the detection processing for the face image area in the subsequent frame from the initial state for the entire frame.

By providing the functional configuration as described above, according to this application example, when the reliability of the estimation result by the search unit 4b in a certain image frame exceeds the threshold value, it is determined that the feature point of the face has been estimated with high reliability, and the tracking flag is turned on, while the coordinates of the face image area estimated in the frame are stored into the tracking information storage unit 7. Then, in the next frame, the face image area is detected taking the coordinates of the face image area stored in the tracking information storage unit 7 as the reference position. Thus, as compared with a case where the face image area is always detected from the initial state in each frame, the face image area can be detected efficiently.

On the other hand, in a state where the tracking flag is on, namely, the tracking mode is set, the search controller 6 determines whether the amount of interframe change in the positional coordinates of the feature point of the face is within the predetermined range, whether the amount of interframe change in the face orientation is within the predetermined angle range, and whether the amount of interframe change in the sight line direction is within the predetermined range. When the determination conditions are satisfied in all these determinations, even when the estimation result in the current frame changes with respect to the previous frame, the change is considered as being within an allowable range, and continuously in the subsequent frame, the detection processing for the face image area is performed taking the positional coordinates of the face image area stored in the tracking information storage unit 7 as the reference position.

Thus, for example, even when a part of the driver's face is temporarily hidden by the hand, hair, or the like or a part of the face is temporarily out of the face image area being tracked along with the body movement of the driver, the tracking mode is kept, and in the subsequent frame, the detection processing for the face image area is continuously performed taking the coordinates of the face image area stored in the tracking information storage unit 7 as the reference position. Hence it is possible to enhance the stability of the processing of estimating the position of the feature point of the face by the search unit 4b, the orientation of the face, and the sight line direction.

Note that at the time of determining whether or not to keep the tracking mode by using the above determination conditions, even when not all the above three determination conditions are satisfied, the tracking mode may be kept so long as one or two of these determination conditions are satisfied.

### One Embodiment

### Configuration Example

(1) System

As described in the application example, the image analysis apparatus according to one or more embodiments is used, for example, in the driver monitoring system that monitors the state of the driver's face. The driver monitoring system includes, for example, a camera 1 and an image analysis apparatus 2.

The camera 1 is disposed, for example, at a position of the dashboard facing the driver. The camera 1 uses, for example, a complementary metal-oxide-semiconductor (CMOS) image sensor capable of receiving near infrared light as an imaging device. The camera 1 captures an image of a predetermined range including the driver's face and transmits its image signal to the image analysis apparatus 2 via, for example, a signal cable. As the imaging device, another solid-state imaging device such as a charge coupled device (CCD) may be used. Further, the installation position of the camera 1 may be set anywhere as long as being a place facing the driver, such as a windshield or a room mirror.

(2) Image Analysis Apparatus

The image analysis apparatus 2 detects the face image area of the driver from the image signal obtained by the camera 1 and detects, the face image area, the state of the driver's face, such as positions of a plurality of feature points preset for a plurality of organs (e.g., eyes, nose, mouth, cheekbones) of the face, the orientation of the face, or the sight line direction.

(2-1) Hardware Configuration

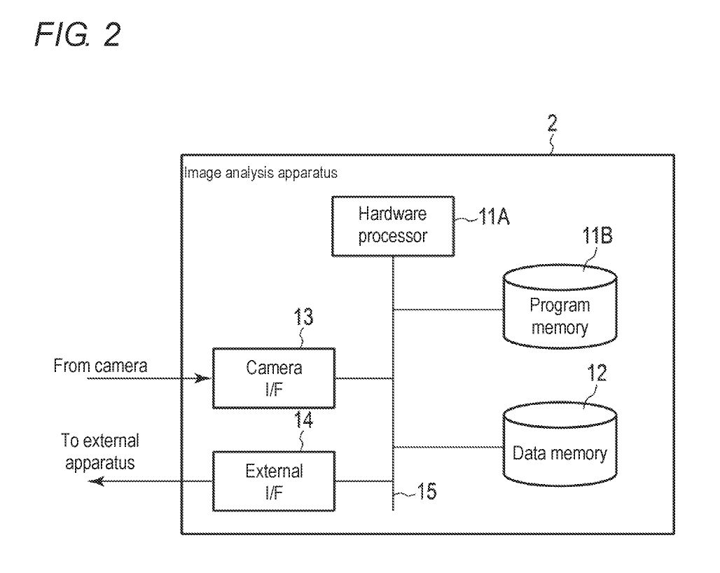

FIG. 2 is a block diagram illustrating an example of a hardware configuration of the image analysis apparatus 2.

The image analysis apparatus 2 has a hardware image analysis apparatus 11A such as a central processing unit (CPU). Then, a program memory 11B, a data memory 12, a camera interface (camera I/F) 13, and an external interface (external I/F) 14 are connected to the hardware processor 11A via a bus 15.

The camera I/F 13 receives an image signal output from the camera 1 via a signal cable, for example. The external I/F 14 outputs information representing the detection result of the state of the face to an external apparatus such as a driver state determination apparatus that determines inattentiveness or drowsiness, an automatic driving control apparatus that controls the operation of the vehicle, and the like.

When an in-vehicle wired network such as a local area network (LAN) and an in-vehicle wireless network adopting a low power wireless data communication standard such as Bluetooth (registered trademark) are provided in the vehicle, signal transmission between the camera 1 and the camera I/F 13 and between the external I/F 14 and the external apparatus may be performed using the network.

The program memory 11B uses, for example, a nonvolatile memory such as a hard disk drive (HDD) or a solid state drive (SSD) that can be written and read as needed and a nonvolatile memory such as a read-only memory (ROM) as storage mediums, and stores programs necessary for executing various kinds of control processing according to one or more embodiments.

The data memory 12 includes, for example, a combination of a nonvolatile memory such as an HDD or an SSD that can be written and read as needed and a volatile memory such as a read-access memory (RAM) as a storage medium. The data memory 12 is used to store various pieces of data acquired, detected, and calculated in the course of executing various processing according to one or more embodiments, template data, and other data.

(2-2) Software Configuration

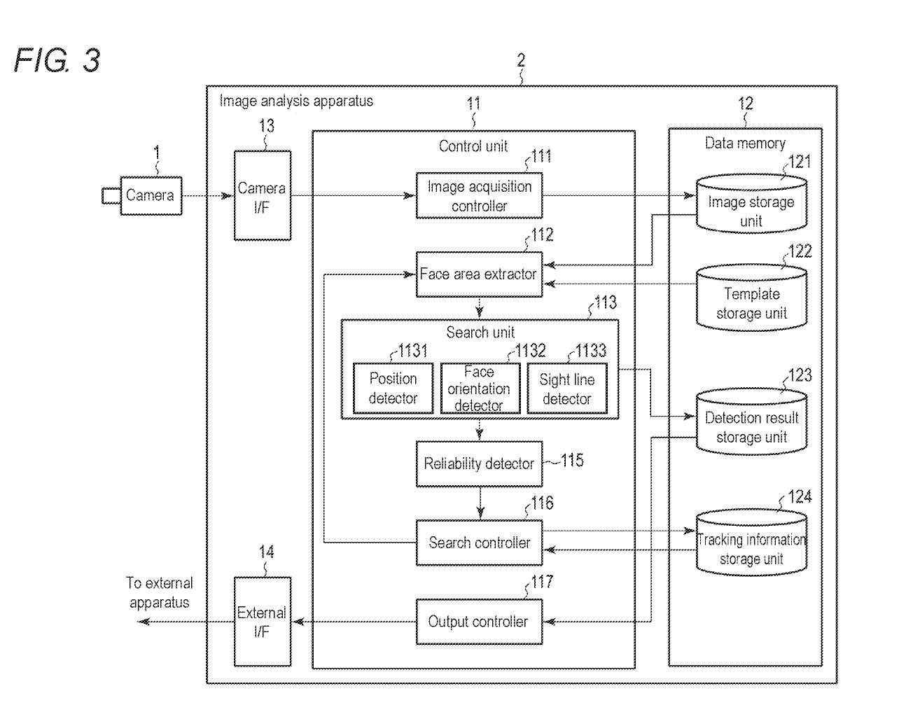

FIG. 3 is a block diagram illustrating a software configuration of the image analysis apparatus 2 according to one or more embodiments. In the storage area of the data memory 12, an image storage unit 121, a template storage unit 122, a detection result storage unit 123, and a tracking information storage unit 124 are provided. The image storage unit 121 is used to temporarily store image data acquired from the camera 1.

The template storage unit 122 stores a face reference template and a three-dimensional face shape model for detecting an image area showing the driver's face from the image data. The three-dimensional face shape model is for detecting a plurality of feature points corresponding to a plurality of organs to be detected (for example, eyes, nose, mouth, cheekbones) from the detected face image area, and a plurality of models are prepared for the orientation of the face.

The detection result storage unit 123 is used to store three-dimensional positional coordinates of a plurality of feature points corresponding to each organ of the face estimated from the face image area, and information representing the orientation of the face and the sight line direction. The tracking information storage unit 124 is used to save the tracking flag and the positional coordinates of the face image area being tracked.

A control unit 11 is made up of the hardware processor 11A and the program memory 11B, and as processing function units by software, the controller 11 includes an image acquisition controller 111, a face area detector 112, a search unit 113, a reliability detector 115, a search controller 116, and an output controller 117. These processing function units are all realized by causing the hardware processor 11A to execute the program stored in the program memory 11B.

The image signals that are output in time series from the camera 1 are received by the camera I/F 13 and converted into image data made of a digital signal for each frame. The image acquisition controller 111 performs processing of taking thereinto the image data for each frame from the camera I/F 13 and saving the image data into the image storage unit 121 of the data memory 12.

The face area detector 112 reads the image data from the image storage unit 121 for each frame. The image area showing the driver's face is detected from the read image data by using the face reference template stored in advance in the template storage unit 122. For example, the face area detector 112 moves the face reference template stepwise at a plurality of preset pixel intervals (e.g., 8 pixels) with respect to the image data, and calculates a luminance correlation value between the reference template and the image data for each movement. Then, the calculated correlation value is compared with a preset threshold value, and the image area corresponding to the step position with the calculated correlation value equal to or greater than the threshold value is extracted as the face area showing the driver's face by the rectangular frame. The size of the rectangular frame is preset in accordance with the size of the driver's face shown in the captured image.

As the face reference template image, for example, a reference template corresponding to the contour of the entire face and a template based on each of general organs (eyes, nose, mouth, cheekbones, etc.) of the face can be used. As a method of detecting a face by template matching, for example, there can be used of a method of detecting a vertex of a head or the like by chromakey processing and detecting a face based on the vertex, a method of detecting an area close to a skin color and detecting the area as a face, or other methods. Further, the face area detector 112 may be configured to perform learning with a teacher signal through a neural network and detect an area that looks like a face as a face. In addition, the detection processing for the face image area by the face area detector 112 may be realized by applying any existing technology.

The search unit 113 includes a position detector 1131, a face orientation detector 1132, and a sight line detector 1133. The position detector 1131, for example, detects a plurality of feature points set corresponding to the respective organs of the face, such as the eyes, nose, mouth, and cheekbones, from the face image area detected by the face area detector 112 by using the three-dimensional face shape model stored in the template storage unit 122, and estimates positional coordinates of the feature points. As described in the application example and the like earlier, a plurality of three-dimensional face shape models are prepared for a plurality of orientations of the driver's face. For example, models corresponding to representative face orientations such as a front direction, a diagonally right direction, a diagonally left direction, a diagonally upward direction, and a diagonally downward direction of the face are prepared. Note that the face orientation may be defined in each of two axial directions being a yaw direction and a pitch direction at intervals of a constant angle, and a three-dimensional face shape model corresponding to a combination of all angles of these respective axes may be prepared. The three-dimensional face shape model is preferably generated by learning processing in accordance with the actual driver's face, for example, but may be a model set with an average initial parameter acquired from a general face image.

For example, the face orientation detector 1132 estimates the orientation of the driver's face based on the positional coordinates of each of the feature point at the time when the error with respect to the correct value is the smallest by the search for the feature point, and the three-dimensional face shape model used for detecting the positional coordinates. The sight line detector 1133 calculates the sight line direction of the driver based on, for example, a three-dimensional position of a bright spot of an eye ball and a two-dimensional position of a pupil among the positions of the plurality of feature points estimated by the position detector 1131.

The reliability detector 115 calculates a reliability α of the position of the feature point estimated by the search unit 113. As a method for detecting the reliability, for example, there is used a method in which a feature of a face image stored in advance and the feature of the face image area detected by the search unit 113 are compared to obtain a probability that an image of the detected face area is the image of the subject, and the reliability is calculated from this probability.

Based on the reliability α detected by the reliability detector 115, the positional coordinates of the feature point estimated by the position detector 1131, the face orientation estimated by the face orientation detector 1132, and the sight line direction estimated by the sight line detector 1133, the search controller 116 executes search control as follows.

(1) In the current frame of image data, when the reliability α of the estimation result by the search unit 113 exceeds a preset threshold value, the tracking flag is set on, and coordinates of the face image area detected in the above frame is saved into the tracking information storage unit 7. That is, the tracking mode is set. Then, the face area detector 112 is instructed to use the saved positional coordinates of the face image area as a reference position at the time of detecting the face image area in the subsequent frame of the image data.

(2) In a state where the tracking mode is set, the search controller 6 determines:
(a) whether or not the amount of change in the coordinates of the feature point of the face detected in the current frame with respect to the estimation result in the previous frame is within the predetermined range;
(b) whether or not the amount of change in the face orientation detected in the current frame with respect to the estimation result in the previous frame is within the predetermined angle range; and
(c) whether or not the amount of change in the sight line direction detected in the current frame with respect to the estimation result in the previous frame is within the predetermined range.

When it is determined that all the determination conditions (a) to (c) are satisfied, the search controller 116 keeps the tracking mode. That is, the tracking flag is kept on and the coordinates of the face image area saved in the tracking information storage unit 7 also continues to be held. Then, the coordinates of the saved face image area are continuously provided to the face area detector 112 so that the face image area can be used as the reference position for detecting the face area in the subsequent frame.

(3) In contrast, when the amount of change in the estimation result in the current frame with respect to the estimation result in the previous frame does not satisfy any one of the above three types of determination conditions (a) to (c), the search controller 6 resets the tracking flag to be off and deletes the coordinates of the face image area saved in the tracking information storage unit 7. That is, the tracking mode is canceled. Then, the face area detector 112 is instructed to restart the detection processing for the face image area in the subsequent frame from the initial state for the entire frame until a new tracking mode is set.

The output controller 117 reads from the detection result storage unit 123 the three-dimensional positional coordinates of each feature point in the face image area, the information representing the face orientation, and the information representing the sight line direction, obtained by the search unit 113, and transmits the read data from the external I/F 14 to the external apparatus. As the external apparatus to which the read data is transmitted, for example, an inattention warning apparatus, an automatic driving control apparatus, and the like can be considered.

### Operation Example

Next, an operation example of the image analysis apparatus 2 configured as described above will be described.

In this example, it is assumed that the face reference template used for the processing of detecting the image area including the face from the captured image data is previously stored in the template storage unit 122.

(1) Learning Processing

First, learning processing required for operating the image analysis apparatus 2 will be described.

The learning processing needs to be performed in advance in order to detect the position of the feature point from the image data by the image analysis apparatus 2.

The learning processing is executed by a learning processing program (not illustrated) installed in the image analysis apparatus 2 in advance. Note that the learning processing may be executed by an information processing apparatus such as a server provided on a network other than the image analysis apparatus 2, and the learning result may be downloaded to the image analysis apparatus 2 via the network and stored into the template storage unit 122.

The learning processing is made up of, for example, processing of acquiring a three-dimensional face shape model, processing of projecting a three-dimensional face shape model onto an image plane, feature amount sampling processing, and processing of acquiring an error detection matrix.

In the learning processing, a plurality of learning face images (hereinafter referred to as “face images” in the description of the learning processing) and three-dimensional coordinates of the feature points in each face image are prepared. The feature points can be acquired by a technique such as a laser scanner or a stereo camera, but any other technique may be used. In order to enhance the accuracy of the learning processing, this feature point extraction processing is preferably performed on a human face.

FIG. 12 is a view exemplifying positions of feature point as objects to be detected of a face on a two-dimensional plane, and FIG. 13 is a diagram illustrating the above feature point as three-dimensional coordinates. In the examples of FIGS. 12 and 13, the case is illustrated where both ends (the inner corner and the outer corner of the eye) of and the center the eyes, the right and left cheek portions (orbital bottom portions), the vertex and the right and left end points of the nose, the right and left mouth corners, the center of the mouth, and the midpoints of the right and left points of the nose and the right and left mouth corners are set as feature points.

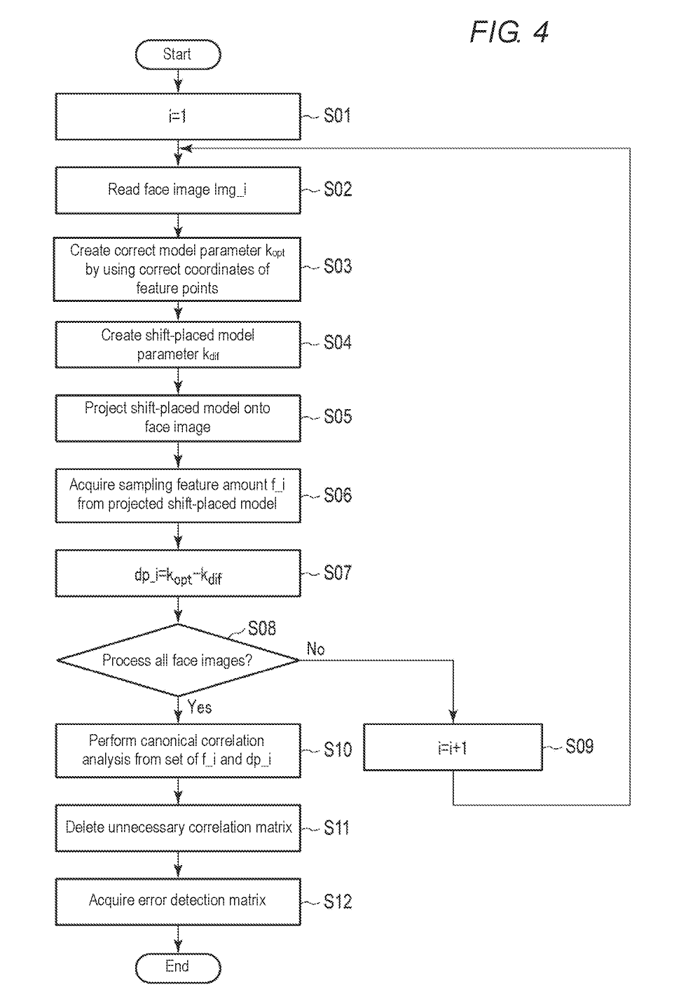

FIG. 4 is a flowchart illustrating an example of the processing procedure and processing contents of the learning processing executed by the image analysis apparatus 2.

(1-1) Acquisition of Three-Dimensional Face Shape Model

First, in step S01, the image analysis apparatus 2 defines a variable i and substitutes 1 for this variable i. Next, in step S02, among the learning face images for which the three-dimensional positions of the feature points have been acquired in advance, a face image (Img_i) of an ith frame is read from the image storage unit 121. With 1 being substituted in i, a face image (Img-1) of a first frame is read. Subsequently, in step S03, a set of correct coordinates of the feature points of the face image Img_i is read, a correct model parameter kopt is acquired, and a correct model of the three-dimensional face shape model is created. Next, in step S04, the image analysis apparatus 2 creates a shift-placed model parameter kdif based on the correct model parameter kopt, and creates a shift-placed model. This shift-placed model is preferably created by generating a random number and making a shift from the correct model within a predetermined range.

The above processing will be specifically described. First, the coordinates of each feature point pi are denoted as pi(xi, yi, zi). At this time, i indicates a value from 1 to n (n indicates the number of the feature point). Next, a feature point arrangement vector X for each face image is defined as in [Formula 1]. The feature point arrangement vector for a face image j is denoted as Xj. The dimension number of X is 3n.

X=[x₁,y₁,z₁,x₂,y₂,z₂, . . . ,xₙ,yₙ,zₙ]^{T} [Formula 1]

The three-dimensional face shape model used in one or more embodiments is, for example as exemplified in FIGS. 12 and 13, used to search many feature points relating to the eyes, nose, mouth, and cheekbones, so that the dimension number X of the feature point arrangement vector X corresponds to the above large number of feature points.

Next, the image analysis apparatus 2 normalizes all the acquired feature point arrangement vectors X based on an appropriate reference. A designer may appropriately determine the reference of normalization at this time. A specific example of normalization will be described below. For example, when gravity center coordinates of points p1 to pn with respect to a feature point arrangement vector Xj for a certain face image j is p_{G}, after each point is moved to the coordinate system having the gravity center p_{G} as the origin, the size can be normalized using Lm defined by [Formula 2]. Specifically, the size can be normalized by dividing the moved coordinate value by Lm. Here, Lm is an average value of a linear distances from the gravity center to each point.

$$Lm = \frac{1}{n} {\sum }_{i = 1}^{n} \sqrt{{( {x}_{i} - {x}_{G} )}^{2} + {( {y}_{i} - {y}_{G} )}^{2} + {( {z}_{i} - {z}_{G} )}^{2}} \qquad [ Formula 2 ]$$

Further, rotation can be normalized by, for example, performing rotational transformation on the feature point coordinates so that a straight line connecting the centers of the eyes faces a certain direction. Since the above processing can be expressed by a combination of rotation and enlargement/reduction, the feature point arrangement vector x after normalization can be expressed as in [Formula 3] (similarity transformation).

$$x = {sR}_{x} {R}_{y} {R}_{z} X + t \\ ( \begin{matrix} {R}_{x} = [ \begin{matrix}1 & 0 & 0 \\ 0 & cos θ & - sin θ \\ 0 & sin θ & cos θ\end{matrix} ] , {R}_{y} = [ \begin{matrix}cos φ & 0 & sin φ \\ 0 & 1 & 0 \\ - sin φ & 0 & cos φ\end{matrix} ] , \\ {R}_{z} = [ \begin{matrix}cos ψ & - sin ψ & 0 \\ sin ψ & cos ψ & 0 \\ 0 & 0 & 1\end{matrix} ] \\ t = [ \begin{matrix}{t}_{x} \\ {t}_{y} \\ {t}_{z}\end{matrix} ]\end{matrix} ) \qquad [ Formula 3 ]$$

Next, the image analysis apparatus 2 performs principal component analysis on the set of the normalized feature point arrangement vectors. The principal component analysis can be performed, for example, as follows. First, according to an equation expressed in [Formula 4], a mean vector (a mean vector is indicated by putting down a horizontal line above x) is acquired. In Formula 4, N represents the number of face images, namely, the number of feature point arrangement vectors.

$$\overline{x} = \frac{1}{N} {\sum }_{j = 1}^{N} {x}_{j} \qquad [ Formula 4 ]$$

Then, as expressed in [Formula 5], a difference vector x′ is obtained by subtracting the mean vector from all the normalized feature point arrangement vectors. The difference vector for image j is denoted as x′j.

X′ⱼ=xⱼ−x̅ [Formula 5]

As a result of the above principal component analysis, 3n pairs of eigenvectors and eigenvalues are obtained. An arbitrary normalized feature point arrangement vector can be expressed by an equation in [Formula 6].

x=x̅+Pb [Formula 6]

where P denotes an eigenvector matrix, and b denotes a shape parameter vector. The respective values are as expressed in [Formula 7]. In addition, ei denotes an eigenvector.

P=[e₁,e₂, . . . ,e₃ₙ]^{T}

b=[b₁,b₂, . . . ,b₃ₙ] [Formula 7]

In practice, by using a value up to high-order k dimensions with large eigenvalues, an arbitrary normalized feature point arrangement vector x can be approximated expressed as in [Formula 8]. Hereinafter, ei is referred to as an ith principal component in descending order of eigenvalues.

x=x̅+P′b′

P′=[e₁,e₂. . . ,eₖ]^{T}

b′=[b₁,b₂, . . . ,bₖ] [Formula 8]

At the time of fitting the face shape model to an actual face image, similarity transformation (translation, rotation) is performed on the normalized feature point arrangement vector x. When parameters of similarity transformation are sx, sy, sz, sθ, sφ, sψ, the model parameter k can be expressed as in [Formula 9] together with the shape parameter.

k=└sₓ,s_{y},s_{z},s_{θ},s_{ϕ},s_{ψ},b₁,b₂, . . . ,bₖ┘ [Formula 9]

When the three-dimensional face shape model expressed by this model parameter k substantially exactly matches the feature point position on a certain face image, the parameter is referred to as a three-dimensional correct model parameter in the face image. The exact matching is determined based on a threshold value and a reference set by the designer.

(1-2) Projection Processing

In step S05, the image analysis apparatus 2 projects the shift-placed model onto the learning image. Projecting the three-dimensional face shape model onto a two-dimensional plane enables the processing to be performed on the two-dimensional image. As a method of projecting the three-dimensional shape onto the two-dimensional plane, various methods exist, such as a parallel projection method and a perspective projection method. Here, a description will be given by taking single point perspective projection as an example among the perspective projection methods. However, the same effect can be obtained using any other method. The single point perspective projection matrix on the z=0 plane is expressed as in [Formula 10].

$$T = [ \begin{matrix}1 & 0 & 0 & 0 \\ 0 & 1 & 0 & 0 \\ 0 & 0 & 0 & r \\ 0 & 0 & 0 & 1\end{matrix} ] \qquad [ Formula 10 ]$$

where r=−1/z, and zc denotes a projection center on the z axis. As a result, the three-dimensional coordinates [x, y, z] are transformed as in [Formula 11] and expressed by the coordinate system on the z=0 plane as in [Formula 12].

$$\begin{matrix}[ x y z 1 ] [ \begin{matrix}1 & 0 & 0 & 0 \\ 0 & 1 & 0 & 0 \\ 0 & 0 & 0 & r \\ 0 & 0 & 0 & 1\end{matrix} ] = [ x y 0 rz + 1 ] & [ Formula 11 ] \\ [ {x}^{*} {y}^{*} ] = [ \frac{x}{rz + 1} \frac{y}{rz + 1} ] & [ Formula 12 ]\end{matrix}$$

By the above processing, the three-dimensional face shape model is projected onto the two-dimensional plane.

(1-3) Feature Amount Sampling

Next, in step S06, the image analysis apparatus 2 executes sampling by using the retina structure based on the two-dimensional face shape model onto which the shift-placed model has been projected, and acquires the sampling feature amount f_i.

Sampling of the feature amount is performed by combining a variable retina structure with the face shape model projected onto the image. The retina structure is a structure of sampling points radially and discretely arranged around a certain feature point (node) of interest. Performing sampling by the retina structure enables efficient low-dimensional sampling of information around the feature point. In this learning processing, sampling is performed by the retina structure at a projection point (each point p) of each node of the face shape model (hereinafter referred to as a two-dimensional face shape model) projected from the three-dimensional face shape model onto the two-dimensional plane. Note that sampling by the retina structure refers to performing sampling at sampling points determined in accordance with the retina structure.

When coordinates of an ith sampling point is qi(xi, yi), the retina structure can be expressed as in [Formula 13].

r=[q₁^{T},q₂^{T}, . . . ,qₘ^{T}]^{T} [Formula 13]

Therefore, for example, a retina feature amount fp obtained by performing sampling by the retina structure for a certain point p(xp, yp) can be expressed as in [Formula 14].

fₚ=[f(p+q₁), . . . ,f(p+qₘ)]^{T} [Formula 14]

where f(p) denotes a feature amount at the point p (sampling point p). Further, the feature amount of each sampling point in the retina structure can be obtained as, for example, a luminance of the image, a Sovel filter feature amount, a Harr Wavelet feature amount, a Gabor Wavelet feature amount, and a combination of these. When the feature amount is multidimensional as in the case of performing the detailed search, the retina feature amount can be expressed as in [Formula 15].

fₚ=[f₁(p+q₁⁽¹⁾), . . . ,f_{D}(p+q₁^{(D)}), . . . ,f₁(p+qₘ⁽¹⁾) . . . ,f_{D}(p+qₘ^{(D)})]^{T} [Formula 15]

where D denotes the dimension number of the feature amount, and fd(p) denotes a d-dimensional feature amount at the point p. qi(d) denotes the ith sampling coordinate of the retina structure with respect to the d-dimensions.

The size of the retina structure can be changed in accordance with the scale of the face shape model. For example, the size of the retina structure can be changed in inverse proportion to a translation parameter sz. At this time, the retina structure r can be expressed as in [Formula 16]. Note that a mentioned here is an appropriate fixed value and is a value different from the reliability α(n) of the search result. Further, the retina structure may be rotated or changed in shape in accordance with other parameters in the face shape model. The retina structure may be set so that its shape (structure) differs depending on each node of the face shape model. The retina structure may have only one center point structure. That is, a structure in which only a feature point (node) is set as a sampling point is included in the retina structure.

r=αs_{z}⁻¹[q₁^{T},q₂^{T}, . . . ,qₘ^{T}]^{T} [Formula 16]

In the three-dimensional face shape model determined by a certain model parameter, a vector obtained by arranging the retina feature amounts obtained by performing the above sampling for the projection point of each node projected onto the projection plane is referred to as the sampling feature amount fin the three-dimensional face shape model. The sampling feature amount f can be expressed as in [Formula 17]. In [Formula 17], n denotes the number of nodes in the face shape model.

f=[fₚ₁^{T},fₚ₂^{T}, . . . ,fₚₙ^{T}]^{T} [Formula 17]

At the time of sampling, each node is normalized. For example, normalization is performed by performing scale transformation so that the feature amount falls within the range of 0 to 1. In addition, normalization may be performed by performing transformation so as to obtain a certain average or variance. Note that there are cases where it is not necessary to perform normalization depending on the feature amount.

(1-4) Acquisition of Error Detection Matrix

Next, in step S07, the image analysis apparatus 2 acquires an error (deviation) dp_i of the shape model based on the correct model parameter kopt and the shift-placed model parameter kdif. Here, in step S08, it is determined whether or not the processing has been completed for all learning face images. This determination can be performed by, for example, comparing the value of i with the number of learning face images. When there is an unprocessed face image, the image analysis apparatus 2 increments the value of i in step S09 and executes the processing in step S02 and the subsequent steps based on the incremented new value of i.

On the other hand, when it is determined that the processing has been completed for all the face images, in step S10, the image analysis apparatus 2 performs canonical correlation analysis on a set of the sampling feature amount f_i obtained for each face image and the difference dp_i from the three-dimensional face shape model obtained for each face image. Then, an unnecessary correlation matrix corresponding to a fixed value smaller than a predetermined threshold value is deleted in step S11, and a final error detection matrix is obtained in step S12.

The error detection matrix is acquired by using canonical correlation analysis. The canonical correlation analysis is one of methods for finding the correlation between different variates of two dimensions. By the canonical correlation analysis, when each node of the face shape model is placed at an erroneous position (a position different from the feature point to be detected), it is possible to obtain a learning result on the correlation representing which direction should be corrected is set.

First, the image analysis apparatus 2 creates a three-dimensional face shape model from the three-dimensional position information of the feature points of the learning face image. Alternatively, a three-dimensional face shape model is created from the two-dimensional correct coordinate point of the learning face image. Then, a correct model parameter is created from the three-dimensional face shape model. By shifting this correct model parameter within a certain range by a random number or the like, a shift-placed model is created in which at least one of the nodes shifts from the three-dimensional position of the feature point. Then, a learning result on the correlation is acquired using the sampling feature amount acquired based on the shift-placed model and the difference between the shift-placed model and the correct model as a set. Specific processing will be described below.

In the image analysis apparatus 2, firstly, two sets of variate vectors x and y are defined as in [Formula 18]. x indicates the sampling feature amount with respect to the shift-placed model. y indicates the difference between the correct model parameter (kopt) and the shift-placed model parameter (parameter indicating the shift-placed model: kdif).

x=[x₁,x₂, . . . xₚ]^{T}

y=[y₁,y₂, . . . y_{q}]^{T}=kₒₚₜ−k_{dif} [Formula 18]

Two sets of variate vectors are normalized to average “0” and variance “1” in advance for each dimension. The parameters (the average and variance of each dimension) used for normalization are necessary for the feature point detection processing described later. Hereinafter, the parameters are denoted as xave, xvar, yave, yvar, respectively, and are referred to as normalization parameters.

Next, when a linear transformation for two variates is defined as in [Formula 19], a and b that maximize the correlation between u and v are found.

u=a₁x₁+ . . . +aₚxₚ=a^{T}x

v=b₁y₁+ . . . +b_{q}y_{q}=b^{T}y [Formula 19]

When the simultaneous distribution of x and y are considered and the variance-covariance matrix Σ is defined as in [Formula 20], a and b above are obtained as eigenvectors with respect to the maximum eigenvalues at the time of solving general eigenvalue problems represented in [Formula 21].

$$\begin{matrix}Σ = [ \begin{matrix}{Σ}_{XX} & {Σ}_{XY} \\ {Σ}_{YX} & {Σ}_{YY}\end{matrix} ] & [ Formula 20 ] \\ ( {Σ}_{XY} {Σ}_{YY}^{- 1} {Σ}_{YX} - {λ}^{2} {Σ}_{XX} ) A = 0 \\ ( {Σ}_{YX} {Σ}_{XX}^{- 1} {Σ}_{XY} - {λ}^{2} {Σ}_{YY} ) B = 0 & [ Formula 21 ]\end{matrix}$$

Of the above, the eigenvalue problem with the lower dimension is solved first. For example, when the maximum eigenvalue obtained by solving the first expression is denoted as λ1 and the corresponding eigenvector is denoted as a1, a vector b1 is obtained by an equation expressed in [Formula 22].

$${b}_{1} = \frac{1}{{λ}_{1}} {Σ}_{YY}^{- 1} {Σ}_{YX} {a}_{1} \qquad [ Formula 22 ]$$

λ1 obtained in this way is referred to as a first canonical correlation coefficient. In addition, u1 and v1 expressed by [Formula 23] is referred to as first canonical variates.

u₁=a₁^{T}x

v₁=b₁^{T}y [Formula 23]

Hereinafter, canonical variates are sequentially obtained based on the magnitude of the eigenvalues, such as a second canonical variate corresponding to the second largest eigenvalue and a third canonical variate corresponding to the third largest eigenvalue. A vector used for feature point detection processing to be described later is assumed to be a vector up to a Mth canonical variate with an eigenvalue equal to or greater than a certain value (threshold value). The designer may appropriately determine the threshold value at this time. Hereinafter, transformation vector matrices up to the Mth canonical variate are denoted as A′, B′ and referred to as error detection matrices. A′, B′ can be expressed as in [Formula 24].

A′=[a₁, . . . ,a_{M}]

B′=[b₁, . . . ,b_{M}] [Formula 24]

B′ is not generally a square matrix. However, since an inverse matrix is required in the feature point detection processing, a pseudo 0 vector is added to B′ and referred to as a square matrix B″. The square matrix B″ can be expressed as in [Formula 25].

B″=[b₁, . . . ,b_{M},0, . . . ,0] [Formula 25]

Note that the error detection matrix can also be obtained by using analysis methods such as linear regression, linear multiple regression, or nonlinear multiple regression. However, using the canonical correlation analysis makes it possible to ignore the influence of a variate corresponding to a small eigenvalue. It is thus possible to remove the influence of elements not having an influence on the error estimation, and more stable error detection becomes possible. Therefore, unless such an effect is required, it is also possible to acquire an error detection matrix by using the above-described other analysis method instead of the canonical correlation analysis. The error detection matrix can also be obtained by a method such as support vector machine (SVM).

In the learning processing described above, only one shift-placed model is created for each learning face image, but a plurality of shift-placed models may be created. This is realized by repeating the processing in steps S03 to S07 on the learning image a plurality of times (e.g., 10 to 100 times). The above-described learning processing is described in detail in Japanese Patent No. 4093273.

(2) Detection of Driver's Face State

When the above learning processing is ended, the image analysis apparatus 2 performs processing for detecting the state of the driver's face by using the face reference template and the three-dimensional face shape model obtained by the learning processing as follows. In this example, the position of a plurality of feature points corresponding to each organ of the face, the orientation of the face, and the sight line direction are detected as the face state.

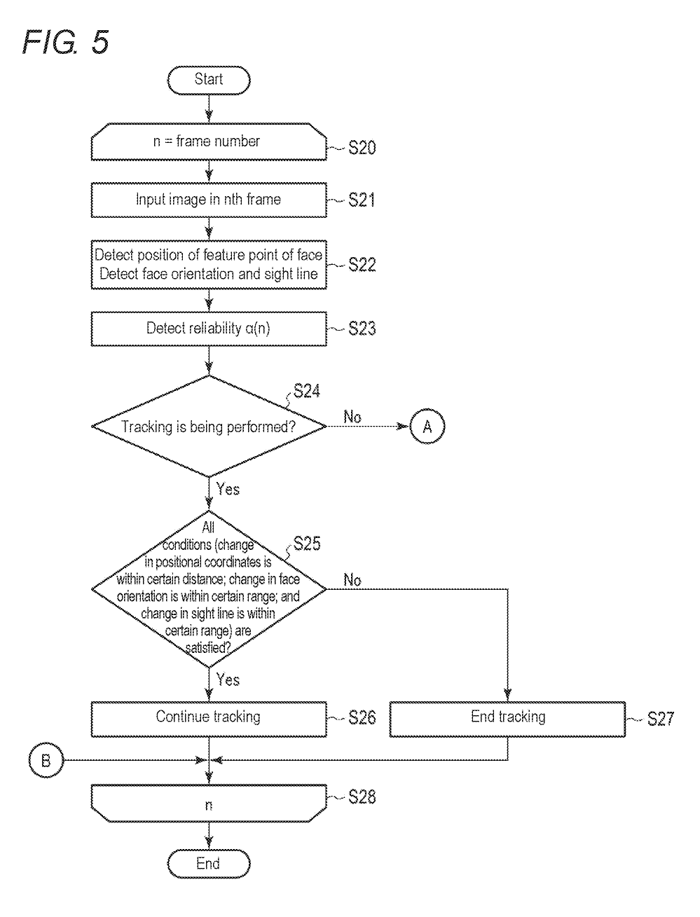

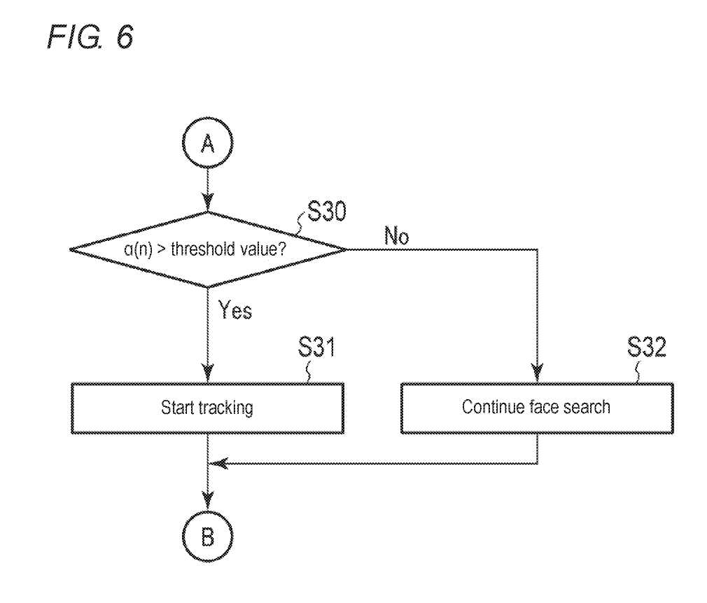

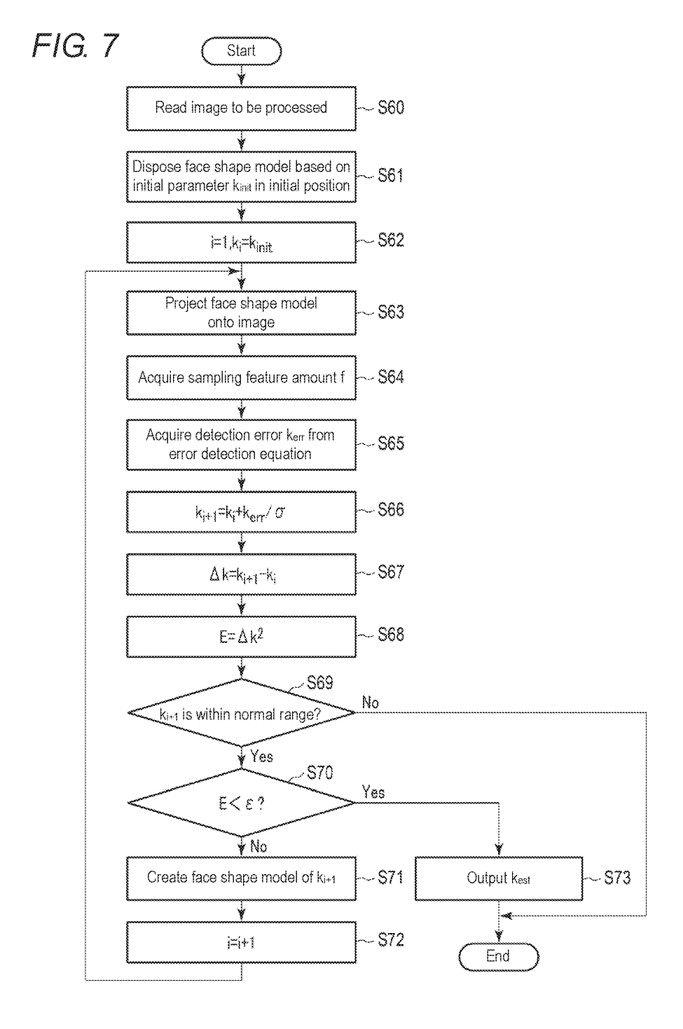

FIG. 5 and FIG. 6 are flowcharts illustrating an example of a processing procedure and processing contents executed by the control unit 11 when detecting the state of the face.

(2-1) Acquisition of Image Data Including Driver's Face

For example, an image of the driver in driving is taken from the front by the camera 1, and the image signal obtained by this is sent from the camera 1 to the image analysis apparatus 2. The image analysis apparatus 2 receives the image signal with the camera I/F 13, and converts the image signal into image data made of a digital signal for each frame.

Under control of the image acquisition controller 111, the image analysis apparatus 2 taking thereinto the image data for each frame and sequentially stores the image data into the image storage unit 121 of the data memory 12. The frame period of the image data stored into the image storage unit 121 can be set arbitrarily.

(2-2) Face Detection (During Non-Tracking)

(2-2-1) Detection of Face Area

Next, under control of the face area detector 112, the image analysis apparatus 2 sets a frame number n to 1 in step S20, and then reads a first frame of the image data from the image storage unit 121 in step S21. Then, under control of the face area detector 112, in step S22, by using the face reference template stored in advance in the template storage unit 122, an image area showing the driver's face is detected from the read image data, and the face image area is extracted with the rectangular frame.

FIG. 9 illustrates an example of the face image area extracted by the face area detection processing, and symbol FC denotes the driver's face.

(2-2-2) Search Processing

Next, under control of the search unit 113, in step S22, the image analysis apparatus 2 estimates the positions of a plurality of feature points set for the organs of the face to be detected, such as the eyes, nose, mouth, and cheekbones, from the face image area extracted by the face area detector 112 with the rectangular frame by using the three-dimensional face shape model created by the previous learning processing.

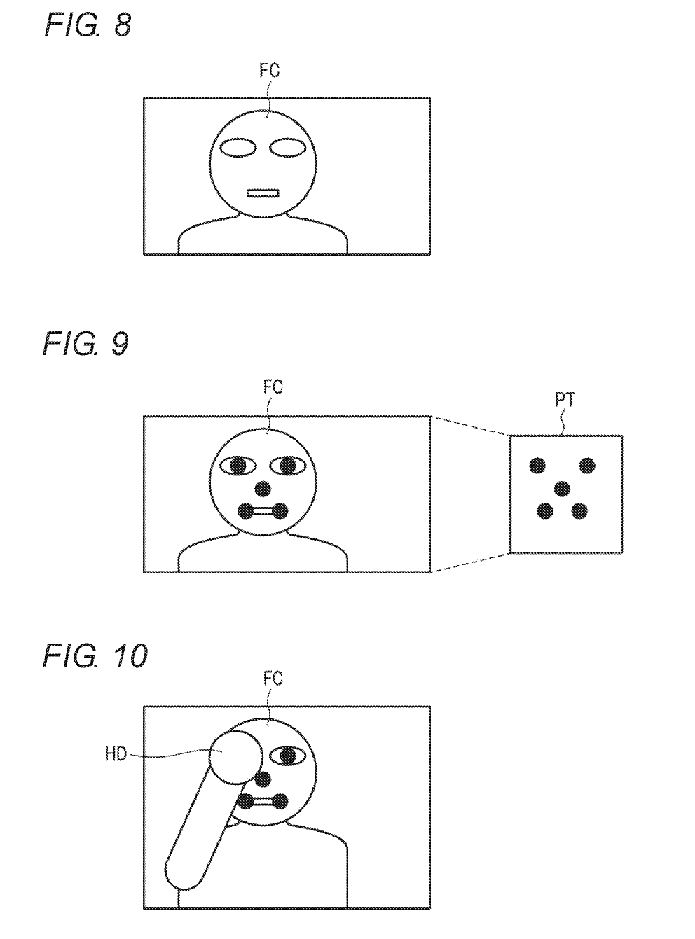

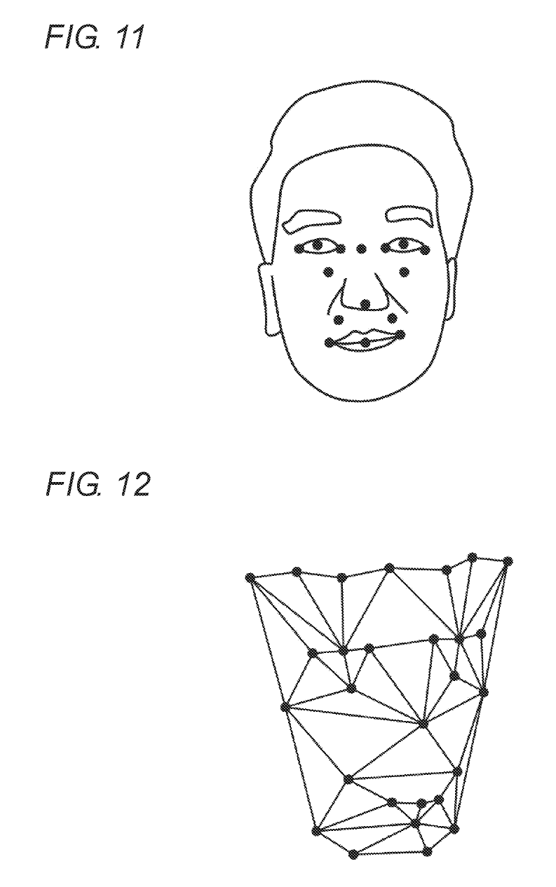

Hereinafter, a description will be given of an example of processing of estimating the position of the feature point by using the three-dimensional face shape model. FIG. 8 is a flowchart illustrating an example of the processing procedure and processing contents. In step S60, the search unit 113 first reads the coordinates of the face image area extracted with the rectangular frame under control of the face area detector 112 from the image storage unit 121 of the data memory 12. Subsequently, in step S61, a three-dimensional face shape model based on an initial parameter kinit is disposed in the initial position of the face image area. Then, in step S62, a variable i is defined, “1” is substituted into this variable, ki is defined, and the initial parameter kinit is substituted into this.

For example, in the case of acquiring the feature amount for the first time from the face image area extracted with the rectangular frame, the search unit 113 first determines a three-dimensional position of each feature point in the three-dimensional face shape model and acquires a parameter (initial parameter) kinit of this three-dimensional face shape model. This three-dimensional face shape model is, for example, disposed so as to be formed in a shape where a limited small number of feature points relating to organs (nodes) such as the eyes, nose, mouth, and cheekbones set in the three-dimensional face shape model are placed at predetermined positions from an arbitrary vertex (e.g., an upper left corner) of the rectangular frame. Note that that the three-dimensional face shape model may have such a shape where the center of the model and the center of the face image area extracted with the rectangular frame match with each other.

The initial parameter kinit is a model parameter represented by an initial value among the model parameters k expressed by [Formula 9]. An appropriate value may be set for the initial parameter kinit. However, by setting an average value obtained from a general face image to the initial parameter kinit, it is possible to deal with various face orientations, changes in facial expression, and the like. Therefore, for example, for the similarity transformation parameters sx, sy, sz, sθ, sφ, sψ, the average value of the correct model parameters of the face image used in the learning processing may be used. Further, for example, the shape parameter b may be set to zero. When information on the face orientation can be obtained by the face area detector 112, the initial parameters may be set using this information. Other values empirically obtained by the designer may be used as initial parameters.

Next, in step S63, the search unit 113 projects the three-dimensional face shape model represented by ki onto the face image area to be processed. Then, in step S64, sampling based on the retina structure is executed using the projected face shape model to acquire the sampling feature amount f. Subsequently, in step S65, error detection processing is executed using the sampling feature amount f. At the time of sampling the feature amount, it is not always necessary to use the retina structure.

On the other hand, when it is the second time or later to acquire the sampling feature amount for the face image area extracted by the face area detector 112, the search unit 113 acquires the sampling feature amount f for the face shape model represented by a new model parameter k obtained by the error detection processing (i.e., a detected value ki+1 of the correct model parameter). In this case as well, in step S65, the error detection processing is executed using the obtained sampling feature amount f.

In the error detection processing, based on the acquired sampling feature amount f, the error detection matrix stored in the template storage unit 122, the normalization parameter, and the like, a detection error kerr between the three-dimensional face shape model ki and the correct model parameter is calculated. Based on the detection error kerr, the detected value ki+1 of the correct model parameter is calculated in step S66. Further, Δk is calculated as the difference between ki+1 and ki in step S67, and E is calculated as a square of Δk in step S68.

In addition, in the error detection processing, the end of the search processing is determined. The processing of detecting the error amount is executed, whereby a new model parameter k is acquired. Hereinafter, a specific processing example of the error detection processing will be described.

First, by using the normalization parameter (xave, xvar), the acquired sampling feature amount f is normalized, and a vector x for performing canonical correlation analysis is obtained. Then, the first to Mth canonical variates are calculated based on an equation expressed in [Formula 26], and thereby a variate u is acquired.

u=[u₁, . . . ,u_{M}]^{T}=A′^{T}x [Formula 26]

Next, a normalized error detection amount y is calculated using an equation expressed in [Formula 27]. In [Formula 27], when B′ is not a square matrix, B′^{T-1} is a pseudo inverse matrix of B′.

y=B″^{T}^{^{−1}}u′ [Formula 27]

Subsequently, restoration processing is performed using the normalization parameter (yave, yvar) for the calculated normalized error detection amount y, thereby acquiring an error detection amount kerr. The error detection amount kerr is an error detection amount from the current face shape model parameter ki to the correct model parameter kopt.

Therefore, the detected value ki+1 of the correct model parameter can be acquired by adding the error detection amount kerr to the current model parameter ki. However, there is a possibility that kerr contains an error. For this reason, in order to perform more stable detection, a detected value ki+1 of the correct model parameter is acquired by an equation represented by [Formula 28]. In [Formula 28], σ is an appropriate fixed value and may be appropriately determined by the designer. Further, σ may change in accordance with the change of i, for example.

$${k}_{i + 1} = {k}_{i} + \frac{{k}_{err}}{σ} \qquad [ Formula 28 ]$$

In the error detection processing, it is preferable to repeatedly perform the sampling processing of the feature amount and the error detection processing so that the detected value ki of the correct model parameter approaches the correct parameter. When such repetitive processing is performed, end determination is performed each time the detected value ki is obtained.

In the end determination, in step S69, it is first determined whether or not the acquired value of ki+1 is within the normal range. As a result of this determination, when the value of ki+1 is not within the normal range, the image analysis apparatus 2 ends the search processing.

In contrast, it is assumed that the value of ki+1 is within the normal range as a result of the determination in step S69. In this case, in step S70, it is determined whether or not the value of E calculated in step S68 exceeds a threshold value ε. If E does not exceed the threshold value ε, it is determined that the processing has converged, and kest is output in step S73. After outputting this kest, the image analysis apparatus 2 ends the detection processing for the face state based on the first frame of the image data.

On the other hand, when E exceeds the threshold value ε, processing of creating a new three-dimensional face shape model is performed based on the value of ki+1 in step S71. Thereafter, the value of i is incremented in step S72, and the processing returns to step S63. Then, the image data of the next frame is taken as the processing target image, and a series of processing from step S63 onwards is repeatedly executed based on the new three-dimensional face shape model.

When the value of i exceeds the threshold value, for example, the processing is ended. Further, the processing may be ended also when, for example, the value of Δk expressed by [Formula 29] is equal to or smaller than the threshold value. In the error detection processing, the end determination may be performed based on whether or not the acquired value of ki+1 is within the normal range. For example, when the acquired value of ki+1 does not clearly indicate the correct position in the image of the human face, the processing is ended. Further, even when a part of the node represented by the acquired ki+1 sticks out of the image to be processed, the processing is ended.

Δk=kᵢ₊₁−kᵢ [Formula 29]

In the error detection processing, when it is determined that the processing is to be continued, the detected value ki+1 of the acquired correct model parameter is passed to the feature amount sampling processing. On the other hand, when it is determined that the processing is to be ended, the detected value ki (or may be ki+1) of the correct model parameter obtained at that time is output as the final detected parameter kest in step S73.

FIG. 10 illustrates an example of the feature points detected by the above search processing, and symbol PT denotes the positions of the feature points.

Incidentally, the processing for searching feature points of a face described above is described in detail in Japanese Patent No. 4093273.

In addition, the search unit 113 detects the orientation of the driver's face based on the positional coordinates of each of the detected feature points and which face orientation the three-dimensional face shape model, used at the time of detecting the above positional coordinates, corresponds to when created.

Further, the search unit 113 specifies an image of the eye in the face image area based on the position of the detected feature point, and detects from this image of the eye the bright spot and the pupil due to the corneal reflection of the eye ball. The sight line direction is calculated from a positional shift amount of the positional coordinates of the pupil with respect to the position of the detected bright spot due to the corneal reflection of the eye ball and a distance D from the camera 1 to the position of the bright spot due to the corneal reflection of the eyeball.

(2-2-3) Detection of Reliability of Estimation Result Obtained by Search Unit 113

When the positions of the plurality of feature points to be detected are detected from the face image area by the above search processing, subsequently, under control of the reliability detector 115, the image analysis apparatus 2 calculates the reliability α(n) (n is a frame number and n=1, here) concerning the position of each feature point estimated by the search unit 113 in step S23. The reliability α(n) can be calculated by, for example, comparing a feature of a face image stored in advance with the feature of the face image area detected by the search unit 113 to obtain a probability that the image of the detected face area is the image of the subject.

(2-2-4) Setting of Tracking Mode

Next, the image analysis apparatus 2 determines whether or not tracking is being performed in step S24 under control of the search controller 116. This determination is made based on whether or not the tracking flag is on. In the current first frame, since the tracking mode has not been set, the search controller 116 proceeds to step S30 illustrated in FIG. 6. Then, the reliability α(n) calculated by the reliability detector 115 is compared with a threshold value. This threshold value is set to an appropriate value in advance.

As a result of the comparison, when the reliability α(n) exceeds the threshold value, the search controller 116 determines that the image of the driver's face can be reliably detected, and proceeds to step S31, and turns on the tracking flag while storing the coordinates of the face image area detected by the face area detector 112 into the tracking information storage unit 124. Thus, the tracking mode is set.

As a result of the comparison in step S30 above, when the reliability α(n) of the detailed search result is equal to or smaller than the threshold value, it is determined that the driver's face could not be detected with good quality in the first frame, and the detection processing for the face image area is continued in step S43. That is, after incrementing the frame number n in step S31, the image analysis apparatus 2 returns to step S20 in FIG. 5 and executes a series of face detection processing on the subsequent second frame by steps S20 to S24 described above and steps S30 to S32 illustrated in FIG. 6.

(2-3) Detection of Face State (while Tracking Mode is Set)

(2-3-1) Detection of Face Area

When the tracking mode is set, the image analysis apparatus 2 executes the detection processing for the face state as follows. That is, under control of the face area detector 112, in step S22, at the time of detecting the driver's face area from the next frame of the image data, the image analysis apparatus 2 takes the coordinates of the face image area detected in the previous frame as the reference position and extracts an image included in the area with the rectangular frame in accordance with tracking information notified from the search controller 116. In this case, the image may be extracted from only the reference position, but the image may also be extracted from each of a plurality of surrounding areas shifted in upward, downward, leftward, and rightward directions by predetermined bits from the reference position.

(2-3-2) Calculation of Reliability of Search Result

Subsequently, under control of the search unit 113, in step S22, the image analysis apparatus 2 searches the position of the feature point of the face to be detected from the extracted face image area. The search processing performed here is the same as the search processing performed on the first frame earlier. Then, under control of the reliability detector 115, in step S23, the image analysis apparatus 2 calculates the reliability α(n) of the above search result (e.g., n=2 when the face detection is being performed for the second frame).

(2-3-3) Continuation of Tracking Mode

Subsequently, under control of the search controller 116, in step S24, the image analysis apparatus 2 determines whether or not the tracking mode is set based on the tracking flag. Since the tracking mode is currently set, the search controller 116 moves to step S25. In step S25, the search controller 116 determines whether or not the state of change in the estimation result in the current frame n with respect to the estimation result in the previous frame n−1 satisfies a preset determination condition.

That is, in this example, it is determined whether or not the amount of change in the estimation result in the current frame n with respect to the estimation result in the previous frame n−1 satisfies each of the following:
(a) the amount of change in positional coordinates of the feature point of the face is within a predetermined range;
(b) the amount of change in the orientation of the face is within a predetermined angle range; and
(c) the amount of change in the sight line direction is within a predetermined range.

Then, when determining that the amount of change in the estimation result in the current frame n with respect to the estimation result in the previous frame n−1 satisfies all the above three types of determination conditions (a) to (c), the search controller 116 considers that the amount of change in the estimation result as being within an allowable range, and proceeds to step S26. In step S26, the search controller 116 saves the positional coordinates of the face image area detected in the current frame into the tracking information storage unit 124 as tracking information. That is, the tracking information is updated. Then, the face detection processing during setting of the tracking mode continues to be performed on the subsequent frames.

Therefore, the search controller 116 continuously provides the saved positional coordinates of the face image area to the face area detector 112, and the face area detector 112 uses the provided face image area as the reference position for detecting the face area in the subsequent frame. Hence in the detection processing for the face area on the subsequent frame, the tracking information is used as the reference position.

FIG. 10 illustrates an example of the case of continuing this tracking mode, and illustrates a case where a part of the driver's face FC is temporarily hidden by the hand HD. Another example of the case of continuing the tracking mode include a case where a part of the face FC is temporarily hidden by the hair, or a case where a part of the face is temporarily out of the face image area being tracked due to a change in the posture of the driver.

(2-3-4) Cancellation of Tracking Mode

In contrast, in step S25 above, when it is determined that the amount of change in the estimation result in the current frame n with respect to the estimation result in the previous frame n−1 does not satisfies all the above three types of determination conditions (a) to (c), it is determined that the amount of change in the estimation result exceeds the allowable range. In this case, in step S27, the search controller 116 resets the tracking flag to be off and deletes the tracking information stored in the tracking information storage unit 124. Thus, in the subsequent frame, the face area detector 112 executes processing of detecting the face area from the initial state without using the tracking information.

### Effect

As described above in detail, in one or more embodiments, in a state where the tracking flag is on, the search controller 6 determines, with respect to a previous frame, whether the amount of change in the positional coordinates of the feature point of the face in the current frame is within the predetermined range, whether the amount of change in the face orientation is within the predetermined angle range, and whether the amount of change in the sight line direction is within the predetermined range. Then, when the conditions are satisfied in all these determinations, the change in the estimation result in the current frame with respect to the previous frame is considered as being within an allowable range, and continuously in the subsequent frame, the processing of estimating each of the estimation results of the position of the feature point, the face orientation, and the sight line direction, which represent the state of the face, is performed in accordance with the face image area saved in the tracking information storage unit 7.

Thus, for example, even when a part of the driver's face is temporarily hidden by the hand, hair, or the like or a part of the face is temporarily out of the reference position of the face image area along with the body movement of the driver, the tracking mode is kept, and in the subsequent frame, the detection processing for the face image is continuously performed taking the coordinates of the face image area saved in the tracking information storage unit 7 as the reference position. It is thus possible to enhance the stability of the detection processing for the feature points of the face.

### Modified Examples

(1) In one or more embodiments, when the changes in the estimation results in the current frame with respect to the previous frame satisfy all the following conditions:
(a) the amount of change in the coordinates of the feature points of the face is within a predetermined range;
(b) the amount of change in the orientation of the face is within a predetermined angle range; and
(c) the amount of change in the sight line direction is within a predetermined range.

The decrease in the reliability of each of the estimation results in the frame is considered as being within an allowable range and the tracking mode is kept.

However, one or more embodiments are not limited thereto, but the tracking mode is kept when any one or two of the above determination conditions (a), (b), and (c) are satisfied. In this case, only the estimation result corresponding to the satisfactory determination condition may be taken as valid and be able to be output to the external apparatus, and the other estimation results may be taken as invalid and not be output to the external apparatus.

(2) In one or more embodiments, once the mode shifts to the tracking mode, the tracking mode is kept thereafter unless the reliability of the estimation result of the face changes significantly. However, there is a concern that, when the apparatus erroneously detects a still pattern such as a face image of a poster or a pattern of a sheet, the tracking mode may be permanently prevented from being cancelled. Therefore, for example, when the tracking mode continues even after the lapse of a time corresponding to a certain number of frames from shifting to the tracking mode, the tracking mode is forcibly cancelled after the lapse of the above time. In this way, even when an erroneous object is tracked, it is possible to reliably get out of this erroneous tracking mode.

(3) In one or more embodiments, the description has been given taking the case as the example where the positions of a plurality of feature points in accordance with a plurality of organs on the driver's face are estimated from the input image data. However, the object to be detected is not limited thereto and may be any object so long as enabling setting of a shape model. For example, the object to be detected may be a whole-human body image, an organ image obtained by a tomographic imaging apparatus such as computed tomography (CT), or the like. In other words, the present technology can be applied to an object having individual differences in size and an object to be detected deformed without changing the basic shape. Further, even in a rigid object to be detected which does not deform like an industrial product such as a vehicle, an electric product, electronic equipment, or a circuit board, the present technology can be applied since a shape model can be set.

(4) In one or more embodiments, the description has been given taking the case as the example where the face state is detected for each frame of the image data, but it is also possible to detect the face state every plural preset frames. In addition, the configuration of the image analysis apparatus, the procedure and processing contents of the search processing of the feature point of the object to be detected, the shape and size of the extraction frame, and the like can be variously modified without departing from the gist of the present invention.

(5) In one or more embodiments, the description has been given taking the case as the example where, after the image area in which the face exists is detected from the image data in the face area detector, the search unit performs a search for a feature point and the like on the detected face image area to detect a change in positional coordinates of the feature point, a change in face orientation, and change in sight line direction. However, one or more embodiments are not limited thereto. In the step of detecting the image area in which the face exists from the image data in the face area detector, when a search method is used to estimate the position of the feature point of the face by using, for example, a three-dimensional face shape model or the like, the amount of interframe change in the positional coordinates of the feature point detected in the face area detecting step may be detected. The tracking state may be controlled by determining whether or not to keep the tracking state based on the amount of interframe change in the positional coordinates of the feature point detected in the face area detecting step.

Although one or more embodiments have been described in detail above, the above description is merely an example of the present invention in all respects. It goes without saying that various improvements and modifications can be made without departing from the scope of the present invention. That is, in practicing the present invention, a specific configuration according to one or more embodiments may be adopted as appropriate.

In short, the present invention is not limited to the above embodiments, and structural elements can be modified and embodied in the implementation stage without departing from the gist thereof. In addition, various embodiments can be formed by appropriately combining a plurality of constituent elements disclosed in the above embodiments. For example, some constituent elements may be deleted from all the constituent elements shown in one or more embodiments. Further, constituent elements over different embodiments may be combined as appropriate.

### APPENDIX

Part or all of each of the above embodiments may be described as shown in the appended description below in addition to the claims, but it is not limited thereto.

### Appendix 1

An image analysis apparatus including a hardware processor (11A) and a memory (11B), the image analysis apparatus being configured to perform the following by the hardware processor (11A) executing a program stored in the memory (11B):
performing processing of detecting an image area including an object to be detected in units of frames from an image that is input in time series (4a) and estimating a state of the object to be detected based on the detected image area (4b);
detecting a reliability indicating likelihood of the estimated state of the object to be detected (5); and
controlling the processing performed by the search unit based on the detected reliability (6),
the image analysis apparatus being configured to perform the following:
determining whether the reliability detected in a first frame of the image satisfies a preset first reliability condition (6),
saving into a memory (7) a position of the image area detected in the first frame and controlling the search unit such that estimation of the state of the object to be detected in a second frame subsequent to the first frame is performed taking the saved position of the image area as a reference, when the reliability detected in the first frame is determined to satisfy the reliability condition in the first frame (6),
determining whether a change in the state of the object to be detected estimated in the second frame from the first frame satisfies a preset determination condition (6),
controlling detection of the image area including the object to be detected and estimation of the state of the object to be detected such that estimation processing for the state of the object to be detected in a third frame subsequent to the second frame is performed taking the saved position of the image area as a reference, when the change in the state of the object to be detected from the first frame is determined to satisfy the determination condition (6), and
deleting the position of the image area saved in the memory and controlling detection of the image area including the object to be detected and estimation of the state of the object to be detected such that the processing performed by the search unit in the third frame subsequent to the second frame is performed from the detection processing for the image area, when the change in the state of the object to be detected from the first frame is determined not to satisfy the determination condition (6).

### Appendix 2

An image analysis method executed by an apparatus including a hardware processor (11A) and a memory (11B) that stores a program to be executed by the hardware processor (11A), the image analysis method comprising:
a search step (S22) of performing, by the hardware processor (11A), processing of detecting an image area including the object to be detected in units of frames from the image that is input in time series and estimating the state of the object to be detected based on the detected image area;
a reliability detecting step (S23) of detecting, by the hardware processor (11A), a reliability that indicates likelihood of the state of the object to be detected estimated by the search step;
a first determination step (S25) of determining, by the hardware processor (11A), whether a reliability detected by the reliability detecting step in a first frame of the image satisfies a preset first reliability condition;
a first control step (S31) of storing, by the hardware processor (11A), into a memory (7) a position of an image area detected by the search step in the first frame and controlling, by the hardware processor (11A), the processing of the search step such that estimation for the state of the object to be detected in a second frame subsequent to the first frame is performed taking the saved position of the image area as a reference, when the reliability detected in the first frame is determined to satisfy the reliability condition);
a second determination step (S25) of determining, by the hardware processor (11A), whether a change in the state of the object to be detected estimated by the search step (S22) in the second frame from the first frame satisfies a preset determination condition;
a second control step (S26) of controlling, by the hardware processor (11A), the processing of the search step (S22) such that estimation processing for the state of the object to be detected in a third frame subsequent to the second frame is performed taking the saved position of the image area as a reference, when the change in the state of the object to be detected from the first frame is determined to satisfy the determination condition; and
a third control step (S27) of deleting, by the hardware processor (11A), the position of the image area saved in the memory (7) and controlling, by the hardware processor (11A), the search step such that the processing of the search step (S22) in the third frame subsequent to the second frame is performed from the detection processing for the image area, when the change in the state of the object to be detected from the first frame is determined not to satisfy the determination condition.

1. An image analysis apparatus comprising:
a processor configured with a program to perform operations comprising:
operation as a search unit configured to perform processing to detect an image area comprising an object to be detected, the processing being performed in units of frames from an image that is input in time series and to estimate a state of the object to be detected based on the detected image area;
operation as a reliability detector configured to detect a reliability indicating likelihood of the state of the object to be detected estimated by the search unit; and
operation as a search controller configured to control the processing performed by the search unit based on the reliability detected by the reliability detector, wherein
the processor is configured with the program perform operations such that operation as the search controller comprises:
operation as a first determination unit configured to determine whether a reliability detected by the reliability detector in a first frame of the image satisfies a preset first reliability condition,
operation as a first controller configured to save into a memory a position of the image area detected by the search unit in the first frame and configured to control the search unit such that estimation processing for the state of the object to be detected in a second frame subsequent to the first frame is performed taking the saved position of the image area as a reference, in response to the reliability detected in the first frame being determined to satisfy the reliability condition,
operation as a second determination unit configured to determine whether a change in the state of the object to be detected estimated by the search unit in the second frame from the first frame satisfies a preset determination condition,
operation as a second controller configured to control the search unit such that estimation processing for the state of the object to be detected in a third frame subsequent to the second frame is performed taking the saved position of the image area as a reference, in response to the change in the state of the object to be detected from the first frame being determined to satisfy the determination condition, and
operation as a third controller configured to delete the position of the image area saved in the memory and configured to control the processing performed by the search unit such that the processing performed by the search unit in the third frame subsequent to the second frame is performed from the detection processing for the image area, in response to the change in the state of the object to be detected from the first frame being determined not to satisfy the determination condition.

2. The image analysis apparatus according to claim 1, wherein the object to be detected comprises a human face, and the processor is configured with the program perform operations such that operation as the search unit is further configured to estimate the state of the object by estimating at least one of: positions of each of a plurality of feature points preset corresponding to a plurality of organs constituting the human face, an orientation of the human face, and a sight line direction of the human face.

3. The image analysis apparatus according to claim 2, wherein the processor is configured with the program perform operations such that:
operation as the search unit is further configured to perform processing of estimating the positions of the plurality of feature points preset for the plurality of organs constituting the human face in the image area, and
operation as the second determination unit is further configured to perform operations comprising, in response to the determination condition comprising a threshold value defining an allowable amount of interframe change in a position of each of the plurality of feature points estimated by the search unit, determining whether an amount of an interframe change in the position of the feature point between the first frame and the second frame exceeds the threshold value.

4. The image analysis apparatus according to claim 2, wherein the processor is configured with the program perform operations such that:
operation as the search unit is further configured to perform processing of estimating from the image area the orientation of the human face with respect to a reference direction, and
operation as the second determination unit is further configured to perform operations comprising, in response to the determination condition comprising a threshold value defining an allowable amount of interframe change in the orientation of the human face, determining whether an amount of a change in the orientation of the human face between the first frame and the second frame exceeds the threshold value.

5. The image analysis apparatus according to claim 2, wherein the processor is configured with the program perform operations such that:
operation as the search unit is further configured to perform processing of estimating from the image area a sight line of the human face, and
operation as the second determination unit is further configured to perform operations comprising, in response to the determination condition comprising a threshold value defining an allowable amount of interframe change in the sight line direction of the human face, determining whether an amount of a change in the sight line direction of the human face between the first frame and the second frame exceeds the threshold value.

6. An image analysis method executed by an apparatus that estimates a state of an object to be detected based on an image that is input in time series, the image analysis method comprising:
performing processing of detecting an image area comprising the object to be detected in units of frames from the image input in time series and estimating the state of the object to be detected based on the detected image area;
detecting a reliability that indicates likelihood of the estimated state of the object to be detected;
determining whether a detected reliability in a first frame of the image satisfies a preset first reliability condition;
storing into a memory a position of a detected image area in the first frame and controlling the processing such that estimation for the state of the object to be detected in a second frame subsequent to the first frame is performed taking the saved position of the image area as a reference, in response to the reliability detected in the first frame being determined to satisfy the reliability condition;
determining whether a change in the estimated state of the object to be detected in the second frame from the first frame satisfies a preset determination condition;
controlling the processing such that estimation processing for the state of the object to be detected in a third frame subsequent to the second frame is performed taking the saved position of the image area as a reference, in response to the change in the state of the object to be detected from the first frame being determined to satisfy the determination condition; and
deleting the position of the image area saved in the memory and controlling the processing such that the processing in the third frame subsequent to the second frame is performed from the detection processing for the image area, in response to the change in the state of the object to be detected from the first frame being determined not to satisfy the determination condition.

7. A non-transitory computer-readable storage medium storing a program, which when read and executed, causes the processor in the image analysis apparatus to perform operations comprising the operations according to claim 1.

8. A non-transitory computer-readable storage medium storing a program, which when read and executed, causes the processor in the image analysis apparatus to perform operations comprising the operations according to claim 2.

9. A non-transitory computer-readable storage medium storing a program, which when read and executed, causes the processor in the image analysis apparatus to perform operations comprising the operations according to claim 3.

10. A non-transitory computer-readable storage medium storing a program, which when read and executed, causes the processor in the image analysis apparatus to perform operations comprising the operations according to claim 4.

11. A non-transitory computer-readable storage medium storing a program, which when read and executed, causes the processor in the image analysis apparatus to perform operations comprising the operations according to claim 5.
